(19) United States
(12) Patent Application Publication
(10) Pub. No.: US 2012/0109632 A1
(43) Pub. Date: May 3, 2012

(54) PORTABLE ELECTRONIC DEVICE

(75) Inventors: Chikashi SUGIURA, Hamura-shi (JP); Takehiko ISAKA, Hachioji-shi (JP); Takashi SUDO, Fuchu-Shi (JP); Shingo SUZUKI, Akishima-shi (JP)

(73) Assignee: KABUSHIKI KAISHA TOSHIBA, Tokyo (JP)

(21) Appl. No.: 13/187,390

(22) Filed: Jul. 20, 2011

(30) Foreign Application Priority Data
Oct. 28, 2010 (JP) 2010-242474

(51) Int. Cl. G06F 17/28

(52) U.S. Cl. 704/3

(57) ABSTRACT

According to one embodiment, a portable electronic device includes a touch-screen display. The electronic device executes a function which is associated with a display object corresponding to a tap position on the touch-screen display. The electronic device includes at least one microphone, a speech processing module configured to process an input speech signal from the at least one microphone, and a translation result output module configured to output a translation result of a target language. The translation result of the target language is obtained by recognizing and machine-translating the input speech signal which is processed by the speech processing module. The speech processing module detects a tap sound signal in the input speech signal, the tap sound signal being produced by tapping the touch-screen display, and corrects the input speech signal in order to reduce an influence of the detected tap sound signal upon the input speech signal.

### CROSS-REFERENCE TO RELATED APPLICATIONS

This application is based upon and claims the benefit of priority from Japanese Patent Application No. 2010-242474, filed Oct. 28, 2010; the entire contents of which are incorporated herein by reference.

### FIELD

Embodiments described herein relate generally to a portable electronic device for executing various services by making use of a speech signal.

### BACKGROUND

In recent years, various kinds of portable electronic devices, such as smartphones, PDAs and slate PCs, have been developed. Most of such portable electronic devices include a touch-screen display (also referred to as “touch-panel-type display”). By tapping the touch-screen display by a finger, a user can instruct the portable electronic device to execute a function which is associated with the tap position.

In addition, recently, the capabilities of a speech recognition function and a speech synthesis function have remarkably been improved. Thus, in the portable electronic devices, too, there has begun to be a demand for implementing a function for executing services using the speech recognition function and speech synthesis function.

A portable machine-translation device is known as an example of the device including the speech recognition function. The portable machine-translation device recognizes a speech of a first language and translates text data, which is a result of the recognition, to text data of a second language. The text data of the second language is converted to a speech by speech synthesis, and the speech is output from a loudspeaker.

However, the precision of speech recognition is greatly affected by noise. In general, in the field of the speech recognition technology, use has been made of various techniques for eliminating stationary noise such as background noise. The stationary noise, in this context, refers to continuous noise. The frequency characteristics of the stationary noise can be calculated, for example, by analyzing a speech signal in a non-speech section. The influence of stationary noise can be reduced by executing an arithmetic operation for eliminating a noise component from an input speech signal in a frequency region.

However, in the portable electronic device, it is possible that the precision of the speech recognition is greatly affected by not only the stationary noise but also non-stationary noise. The non-stationary noise is, for example, noise, the time of occurrence of which is not understandable, and which occurs instantaneously. Examples of the non-stationary noise include a sound of contact with the device while a speech is being input, a nearby speaker's voice, and a sound reproduced from a loudspeaker of the device.

In many portable electronic devices having the speech recognition function, a microphone is attached to the main body thereof. Hence, if the user touches the main body of the device while a speech is being input, a sound corresponding to the vibration of the device may possibly be input by the microphone. In particular, in the device including the touch-screen display, for example, if the user taps the touch-screen display during the speech input, noise (non-stationary noise) may possibly be mixed in the input speech due to the tap sound.

If such a method is adopted that other operations are prohibited during the speech input, the mixing of noise (non-stationary noise) in the input speech can be reduced. However, if this method is adopted, the user cannot execute other operations on the electronic device during the speech input, leading to the deterioration in usability of the portable electronic device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating the external appearance of a portable electronic device according to an embodiment;

FIG. 2 is an exemplary view illustrating a use case of the portable electronic device of the embodiment;

FIG. 3 is an exemplary block diagram illustrating an example of the system configuration of the portable electronic device of the embodiment;

FIG. 4 is an exemplary view illustrating a waveform example of a tap sound signal which is detected by the portable electronic device of the embodiment;

FIG. 5 is an exemplary view illustrating an example of a saturation waveform which is detected by the portable electronic device of the embodiment;

FIG. 6 is an exemplary view illustrating a waveform example of an input speech signal including a tap sound signal, which is input to the portable electronic device of the embodiment;

FIG. 7 is a view for explaining an example of a speech signal correction process for eliminating a tap sound signal, which is executed by the portable electronic device of the embodiment;

FIG. 8 is an exemplary block diagram illustrating another example of the system configuration of the portable electronic device of the embodiment;

FIG. 9 is an exemplary block diagram illustrating still another example of the system configuration of the portable electronic device of the embodiment;

FIG. 10 is an exemplary block diagram illustrating an example of a speech section which is detected by the portable electronic device of the embodiment;

FIG. 11 is an exemplary flow chart illustrating the procedure of a speech section detection process which is detected by the portable electronic device of the embodiment;

FIG. 12 is an exemplary block diagram illustrating still another example of the system configuration of the portable electronic device of the embodiment; and

FIG. 13 is an exemplary block diagram illustrating still another example of the system configuration of the portable electronic device of the embodiment.

### DETAILED DESCRIPTION

Various embodiments will be described hereinafter with reference to the accompanying drawings.

In general, according to one embodiment, a portable electronic device comprises a main body comprising a touch-screen display, and is configured to execute a function which is associated with a display object corresponding to a tap position on the touch-screen display. The portable electronic device comprises at least one microphone attached to the main body; a speech processing module provided in the main body and configured to process an input speech signal from the at least one microphone; and a translation result output module provided in the main body and configured to output a translation result of a target language, the translation result of the target language being obtained by recognizing and machine-translating the input speech signal which is processed by the speech processing module. The speech processing module is configured to detect a tap sound signal in the input speech signal, the tap sound signal being produced by tapping the touch-screen display, and to correct the input speech signal in order to reduce an influence of the detected tap sound signal upon the input speech signal.

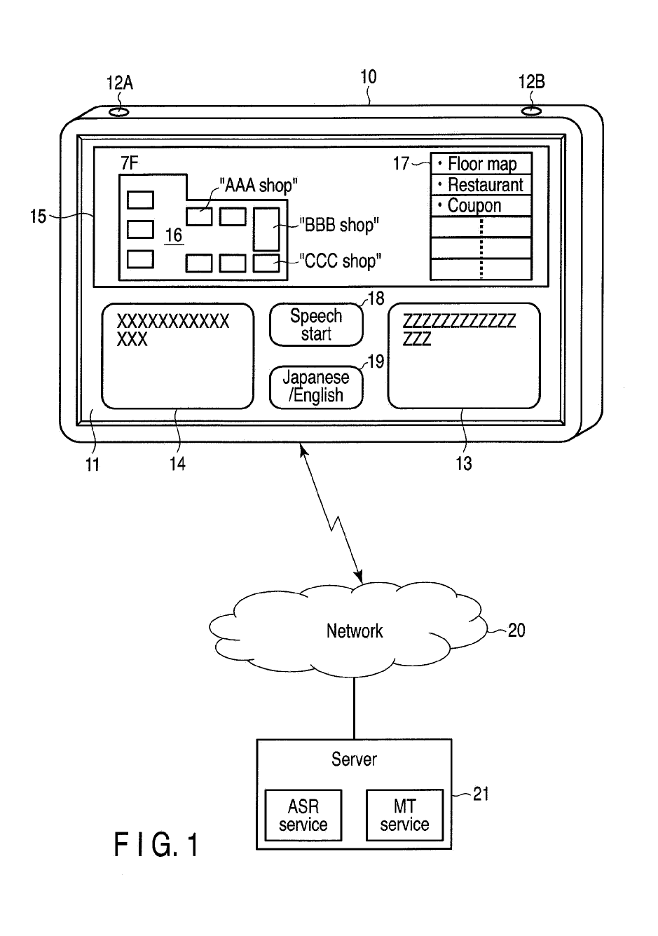

To begin with, referring to FIG. 1, the structure of a portable electronic device according to an embodiment is described. This portable electronic device can be realized, for example, as a smartphone, a PDA or a slate personal computer (slate PC). The portable electronic device comprises a main body 10 with a touch-screen display 11. To be more specific, the main body 10 comprises a thin box-shaped housing, and the touch-screen display 11 is provided on the top surface of the housing. The touch-screen display 11 is a display configured to detect a tap position (touch position) on the screen thereof. The touch-screen display 11 may be composed of a flat-panel display, such as an LCD, and a touch panel.

The portable electronic device is configured to execute a function which is associated with a display object (menu, button, etc.) corresponding to a tap position on the touch-screen display 11. For example, the portable electronic device can execute various services making use of images (e.g. guidance map), which are displayed on the touch-screen display 11, and a voice. The services include a service of supporting a traveler in conversations in an overseas travel, or a service of supporting a shop assistant in attending to a foreign tourist. These services can be realized by using a speech input function, a speech recognition function, a machine translation function and a speech synthesis (text-to-speech) function, which are included in the portable electronic device. Although all of these functions may be executed by the portable electronic device, a part or most of the functions may be executed by a server 21 on a network 20. For example, the speech recognition function and machine translation function may be executed by the server 21 on the network 20, and the speech input function and speech synthesis (text-to-speech) function may be executed by the portable electronic device. In this case, the server 21 may have an automatic speech recognition (ASR) function of recognizing a speech signal which is received from the portable electronic device, and a machine translation (MT) function of translating text obtained by the ASR into a target language. The portable electronic device can receive from the server 21a translation result of the target language which is obtained by the machine translation (MT). The portable electronic device may convert text, which is indicative of the received translation result, to a speech signal, and may output a sound corresponding to the speech signal from a loudspeaker. In addition, the portable electronic device may display text, which is indicated by the received translation result, on the touch-screen display 11.

The main body 10 is provided with one or more microphones. The one or more microphones are used in order to input a speech signal. FIG. 1 shows a structure example in which microphones 12A and 12B are provided on a left end portion and a right end portion of an upper end part of the main body 10.

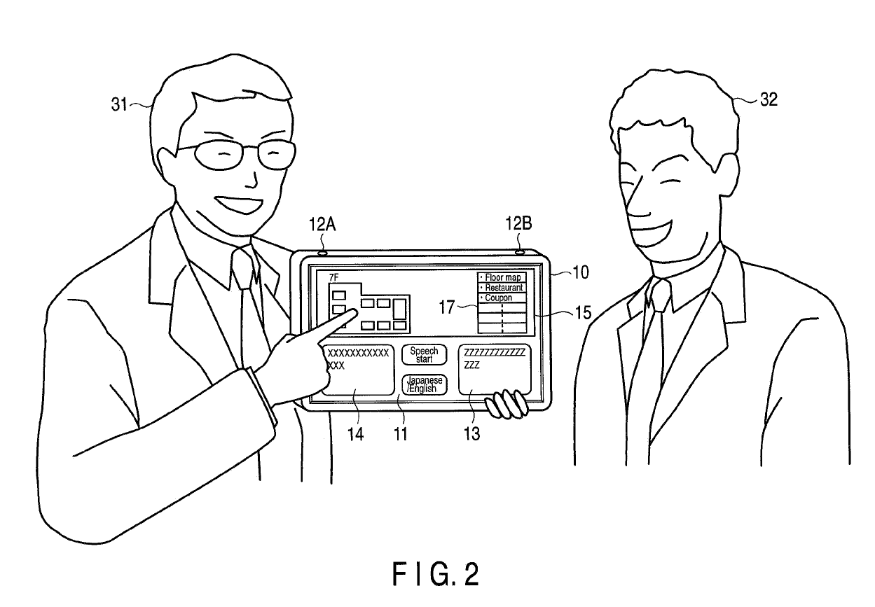

A description is now given of an example of the screen which is displayed on the touch-screen display 11, by illustrating a service of supporting a shop assistant (guide) of a shopping mall in attending to a foreign tourist (foreigner). As shown in FIG. 2, a shop assistant (guide) 31 and a foreigner (guided person) 32 have a conversation while viewing the display screen of the touch-screen display 11. For example, the shop assistant 31 holds the portable electronic device by the left arm, and performs a touch operation (tap operation, drag operation, etc.) on the screen of the touch-screen display 11 by a finger of the right hand, while uttering a speech.

For example, when the foreigner 32 has asked about a salesroom in the shopping mall, like “Where is the ‘xxx’ shop?”, the shop assistant 31 manipulates the touch-screen display 11, while speaking “The ‘xxx’ shop is . . . ”, and causes the device display the map of the ‘xxx’ shop on the touch-screen display 11. During this time, the speech “The ‘xxx’ shop is . . . ”, which was uttered by the shop assistant, is translated into a target language (the language used by the foreigner 32), and the translation result is output from the portable electronic device. In this case, the portable electronic device may convert the text indicative of the translation result of the target language to a speech signal, and may output a sound corresponding to this speech signal. In addition, the portable electronic device may display the text indicative of the translation result of the target language on the touch-screen display 11. Needless to say, the portable electronic device may convert the text indicative of the translation result of the target language to a speech signal and output a sound corresponding to this speech signal, and may also display the text indicative of the translation result of the target language on the touch-screen display 11.

In addition, the portable electronic device can output, by voice or text, a translation result of another target language (the language used by the shop assistant 31), which is obtained by recognizing and translating the speech of the foreigner 32, “Where is the ‘xxx’ shop?”.

Besides, the portable electronic device may display, on the touch-screen display 11, the text of the original language (the text of the language used by the foreigner) indicative of the recognition result of the speech of the foreigner 32, and the text (the text of the language used by the shop assistant 31) indicative of the translation result which is obtained by recognizing and translating the speech of the foreigner 32.

In the description below, for the purpose of easier understanding, it is assumed that the language used by the shop assistant 31 is Japanese and the language used by the foreigner is English. However, the present embodiment is not limited to this case, and is applicable to various cases, such as a case in which the language used by the shop assistant 31 is English and the language used by the foreigner is Chinese, or a case in which the language used by the shop assistant 31 is Chinese and the language used by the foreigner is English.

As shown in FIG. 1, the display screen on the touch-screen display 11 displays, for example, a first display area 13, a second display area 14, a third display area 15, a speech start button 18, and a language display area change-over button 19. The first display area 13 is used, for example, for displaying English text indicative of the content of a speech of the foreigner 32. The second display area 14 is used, for example, for displaying Japanese text which is obtained by translating the content of a speech of the foreigner 32. The third display area 15 is used for displaying a guidance screen which is to be presented to the foreigner 32. The guidance screen displays, for instance, a guidance map 16, a menu 17, etc. The menu 17 displays various items for designating locations which are to be displayed as the guidance map 16. The shop assistant 31 taps one of the items on the menu 17, thus being able to designate a location which is to be displayed as the guidance map 16. FIG. 1 shows an example of display of a salesroom map (floor map) showing the layout of shops on the seventh floor of the shopping mall. On the salesroom map (floor map), for example, Japanese text indicating the names of the shops may be displayed. When Japanese text (e.g. “Japanese restaurant corner”), for instance, on the salesroom map has been tapped by the shop assistant 31, the tapped Japanese text may be recognized and translated and English text corresponding to the “Japanese restaurant corner” may be displayed on the touch-screen display 11, or this English text may be converted to a speech signal and a sound corresponding to the speech signal, which has been obtained by the conversion, may be output.

A Japanese character string indicative of the name of the shop may be displayed on the guidance map 16 by an image. In this case, the portable electronic device may recognize the tapped Japanese character string by character recognition.

The speech start button 18 is a button for instructing the start of the input and recognition of a speech. When the speech start button 18 has been tapped, the portable electronic device may start the input and recognition of a speech. The language display area change-over button 19 is used to switch, between the first display area 13 and second display area 14, the area for displaying English text indicative of a speech content of the foreigner 32 and the area for displaying Japanese text which is obtained by translating the speech content of the foreigner 32.

The display contents of the first display area 13 and second display area 14 are not limited to the above-described examples. For example, the second display area 14 may display either or both of Japanese text indicative of a speech content of the shop assistant 31 and Japanese text obtained by translating a speech content of the foreigner 32, and the first display area 13 may display either or both of English text obtained by translating a speech content of the shop assistant 31 and English text indicative of a speech content of the foreigner 32.

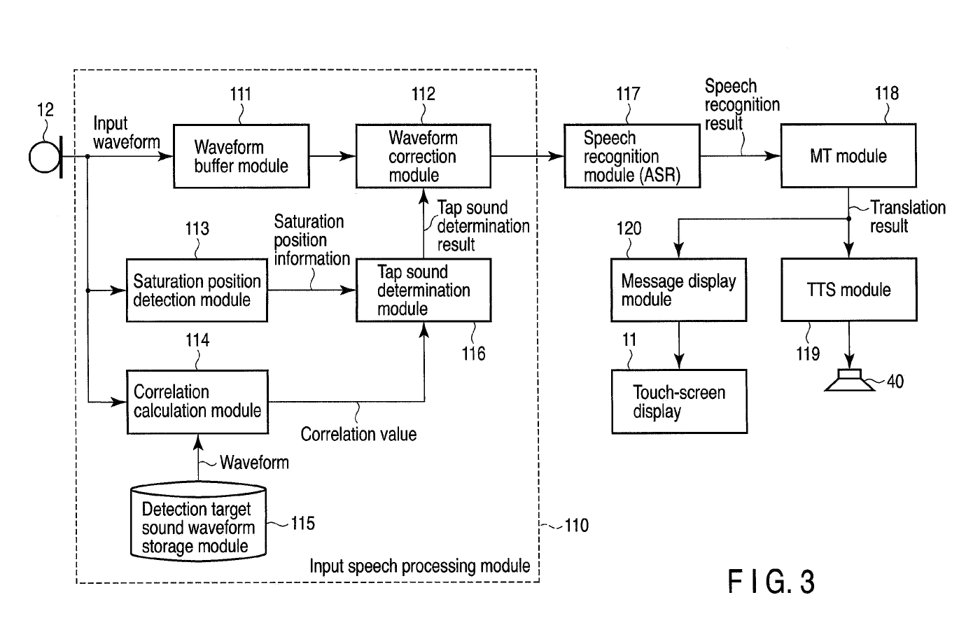

Next, referring to FIG. 3, the system configuration of the portable electronic device of the embodiment is described.

In the example of FIG. 3, the portable electronic device comprises an input speech processing module 110, a speech recognition (ASR) module 117, a machine translation (MT) module 118, a text-to-speech (TTS) module 119, and a message display module 120. A microphone 12 is representative of the above-described microphone 12A, 12B. The input speech processing module 110 is a speech processing module which processes an input speech signal from the microphone 12.

The input speech processing module 110 is configured to detect a tap sound signal included in the input speech signal, and to correct the input speech signal in order to reduce the influence of the detected tap sound signal upon the input speech signal, thereby to enable the shop assistant 31 to operate the portable electronic device while speaking. The tap sound signal is a signal of a sound which is produced by tapping the touch-screen display 11. Since the microphone 12 is directly attached to the main body 10, as described above, if the shop assistant 31 taps the touch-screen display 11 while inputting a speech, it is possible that noise mixes in the input speech signal from the microphone 12 due to the tap sound. The input speech processing module 110 automatically eliminates the tap sound from the input speech signal, and outputs the input speech signal, from which the tap sound has been eliminated, to the following stage. Thereby, even if the shop assistant 31 operates the portable electronic device while the shop assistant 31 or foreigner 32 is uttering a speech, the influence upon the precision of recognition of the input speech signal can be reduced. Therefore, the shop assistant 31 can operate the portable electronic device while uttering a speech.

A tap sound can be detected, for example, by calculating the correlation between an audio signal corresponding to the tap sound and an input speech signal. If the input speech signal includes a waveform similar to the waveform of an audio signal corresponding to a tap sound, a period corresponding to the similar waveform is detected as a tap sound generation period.

In addition, when the tap sound is produced, it is possible that the input speech signal is in a saturation state. Thus, a period in which the input speech signal is in a saturation state may also be detected as a tap sound generation period.

The input speech processing module 110 has the following functions:

(1) A function of processing an input speech signal (input waveform) on a frame-by-frame basis;

(2) A function of detecting a saturation position of an input speech signal (input waveform);

(3) A function of calculating the correlation between an input speech signal (input waveform) and a waveform of an audio signal corresponding to a tap sound; and

(4) A function of correcting an input speech signal (input waveform), thereby eliminating the waveform of the tap sound from the input speech signal (input waveform).

Next, a structure example of the input speech processing module 110 is described.

The input speech processing module 110 comprises a waveform buffer module 111, a waveform correction module 112, a saturation position detection module 113, a correlation calculation module 114, a detection target sound waveform storage module 115, and a tap sound determination module 116.

The waveform buffer module 111 is a memory (buffer) for temporarily storing an input speech signal (input waveform) which is received from the microphone 12. The waveform correction module 112 corrects the input speech signal (input waveform) stored in the waveform buffer module 111, thereby to eliminate a tap sound signal from the input speech signal (input waveform). In this correction, a signal component corresponding to the tap sound generation period (i.e. a waveform component corresponding to the tap sound generation period) may be eliminated from the input speech signal. Since the tap sound is instantaneous noise, as described above, the tap sound generation period is very short (e.g. about 20 ms to 40 ms). Thus, even if the signal component corresponding to the tap sound generation period is eliminated from the input speech signal, the precision of speech recognition of the input speech signal is not adversely affected. If a frequency arithmetic process is executed for subtracting the frequency of the tap sound from the frequency of the input speech signal, it is possible that abnormal noise may mix in the input speech signal due to this frequency arithmetic process. Accordingly, the method of eliminating the signal component corresponding to the tap sound generation period from the input speech signal is more suitable for the elimination of non-stationary noise than the method of using the frequency arithmetic process.

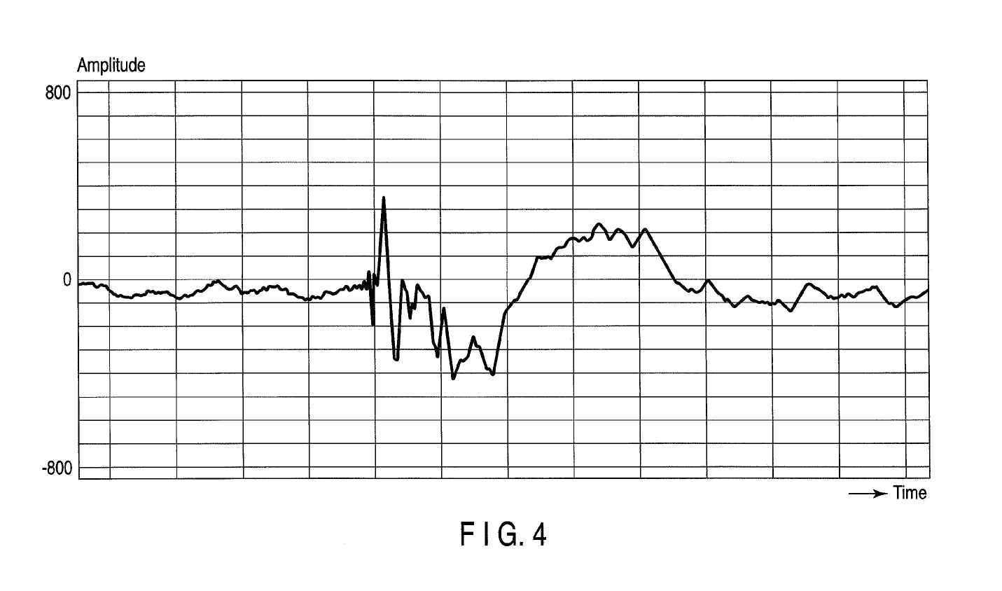

The saturation position detection module 113 detects a saturation position in the input speech signal (input waveform) which is received from the microphone 12. In the case where the state, in which the amplitude level of the input speech signal reaches a neighborhood of the maximum amplitude level or a neighborhood of the minimum amplitude level, continues for a certain period, the saturation position detection module 113 may detect this period as saturation position information. The correlation calculation module 114 calculates the correlation between a detection target sound waveform (tap sound waveform), which is stored in the detection target sound waveform (tap waveform) storage module 115, and the waveform of the input speech signal. The waveform of a tap sound signal, that is, the waveform of an audio signal occurring when the touch-panel display is tapped, is prestored as a detection target sound waveform in the detection target sound waveform (tap waveform) storage module 115. FIG. 4 shows an example of the waveform of a tap sound signal. In FIG. 4, the lateral axis indicates time, and the vertical axis indicates an amplitude.

In order to detect a tap sound signal included in the input speech signal, the tap sound determination module 116 determines whether a current frame of the input speech signal is a tap sound or not, based on the saturation position information (also referred to as “saturation time information”) and the correlation value. This determination may be executed, for example, based on a weighted average of the saturation position information and the correlation value.

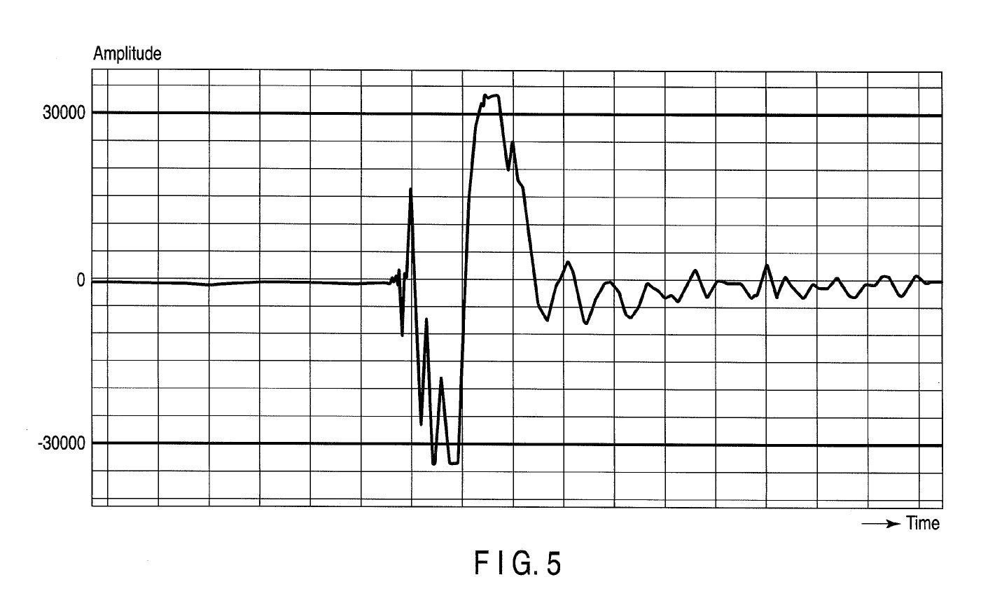

Needless to say, the correlation value and the saturation position information may be individually used. When the input speech signal is in the saturation state, the waveform of the input speech signal is disturbed, and there are cases in which a tap sound cannot be detected by the correlation of waveforms. However, by specifying the period of the input speech signal, in which saturation occurs, based on the saturation position information, this period can be detected as a tap sound generation period. Saturation tends to easily occur, for example, when the nail of the finger has come in contact with the touch-screen display 11 by a tap operation. FIG. 5 illustrates an example of the waveform of a speech signal in which saturation occurs. In FIG. 5, the lateral axis indicates time, and the vertical axis indicates an amplitude. The level of the amplitude of the speech signal, in which saturation occurs, continues for a predetermined period in the neighborhood of the maximum amplitude level or in the neighborhood of the minimum amplitude level.

When the tap sound determination module 116 has determined a tap sound, that is, when the tap sound determination module 116 has determined that the present input speech signal includes a tap sound, the waveform correction module 112 deletes the waveform of a tap sound component from the input speech signal. Furthermore, by overlappingly adding the waveforms of components which precede and follow the tap sound component, the waveform correction module 112 may interpolate the waveform of the deleted tap sound component by using the components which precede and follow the tap sound component.

The speech recognition (ASR) module 117 recognizes the speech signal which has been processed by the input speech processing module 110, and outputs a speech recognition result. The machine translation (MT) module 118 translates text (character string) indicative of the speech recognition result into text (character string) of a target language by machine translation, and outputs a translation result.

The text-to-speech (TTS) module 119 and message display module 120 function as a translation result output module which outputs the translation result of the target language which is obtained by recognizing and machine-translating the input speech signal which has been processed by the input speech processing module 110. To be more specific, the text-to-speech (TTS) module 119 is configured to convert the text indicative of the translation result to a speech signal by a speech synthesis process, and to output a sound corresponding to the speech signal obtained by the conversion by using a loudspeaker 40. The message display module 120 displays the text indicative of the translation result on the touch-panel display 11.

In the meantime, at least one of the functions of the speech recognition (ASR) module 117, machine translation (MT) module 118 and text-to-speech (TTS) module 119 may be executed by the server 21. For example, the function of the text-to-speech (TTS) module 119, the load of which is relatively small, may be executed within the portable electronic device, and the functions of the speech recognition (ASR) module 117 and machine translation (MT) module 118 may be executed by the server 21.

The portable electronic device comprises a CPU (processor), a memory and a wireless communication unit as hardware components. The function of the text-to-speech (TTS) module 119 may be realized by a program which is executed by the CPU. In addition, the functions of the speech recognition (ASR) module 117 and machine translation (MT) module 118 may be realized by a program which is executed by the CPU. Besides, a part or all of the functions of the input speech processing module 100 may be realized by a program which is executed by the CPU. Needless to say, a part or all of the functions of the input speech processing module 100 may be executed by purpose-specific or general-purpose hardware.

In the case of executing the functions of the speech recognition (ASR) module 117 and machine translation (MT) module 118 by the server 21, the portable electronic device may transmit the speech signal, which has been processed by the input speech processing module 110, to the server 21 via the network 20, and may receive a translation result from the server 21 via the network 20. The communication between the portable electronic device and the network 20 can be executed by using the wireless communication unit provided in the portable electronic device.

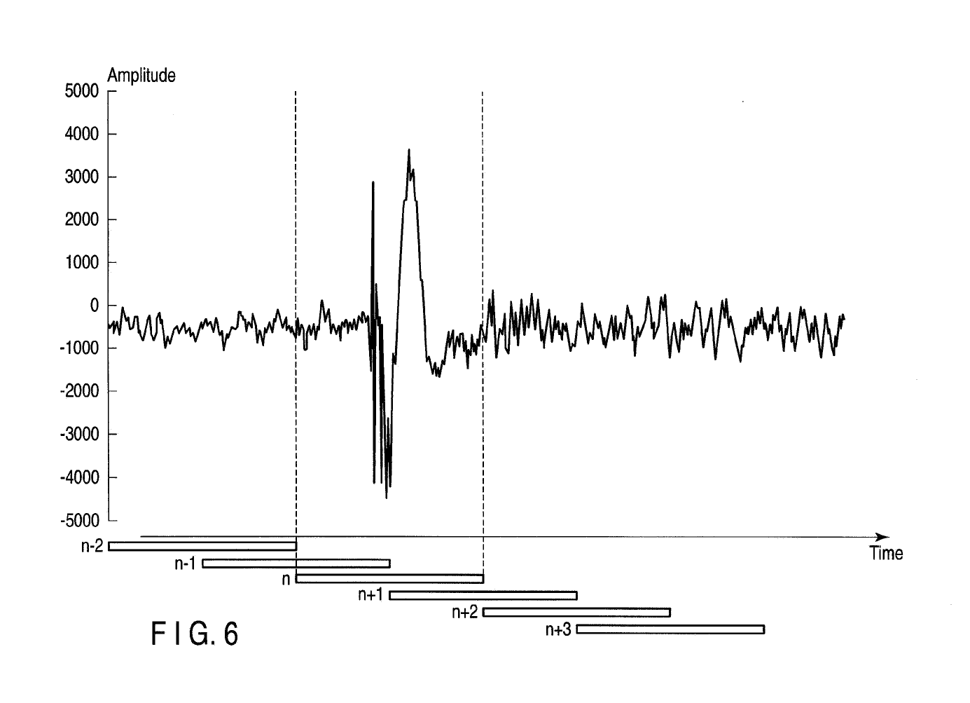

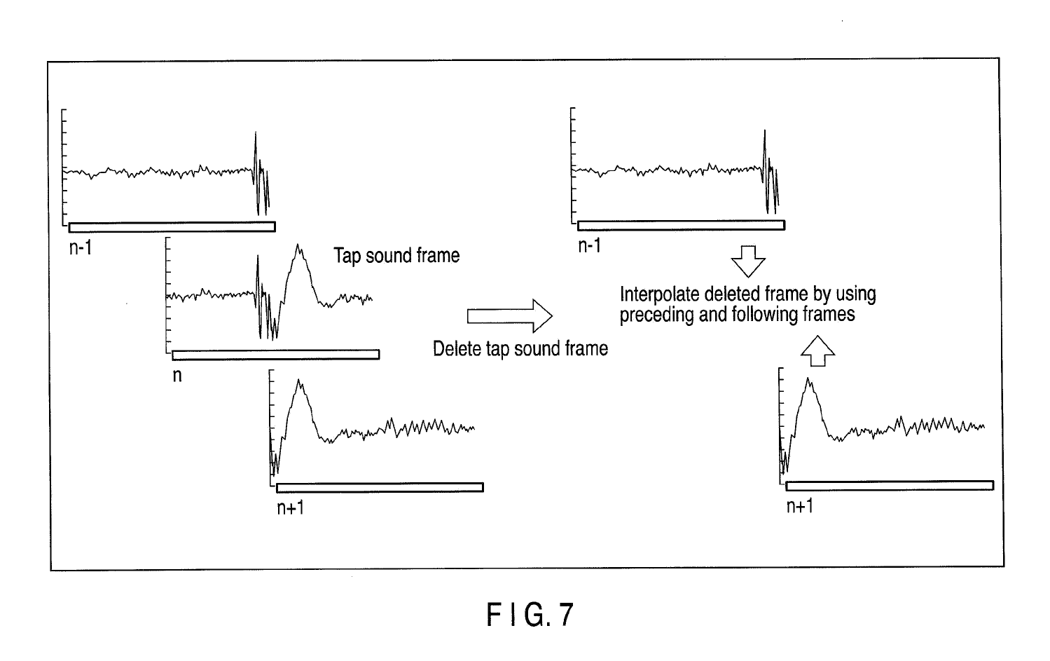

Next, referring to FIG. 6 and FIG. 7, a description is given of an example of a process which is executed by the waveform correction module 112.

FIG. 6 illustrates a waveform example of an input speech signal including a tap sound signal. In FIG. 6, the lateral axis indicates time, and the vertical axis indicates the amplitude of the input speech signal. The processing of the input speech signal is executed in units of a frame of a predetermined period. In the case of this example, use is made of a half-frame shift in which two successive frames overlap by a half-frame length. In FIG. 6, an n frame includes a tap sound signal.

FIG. 7 illustrates an example of a speech signal correction process for eliminating a tap sound signal. The waveform correction module 112 deletes an n frame including a tap sound signal, from the waveform of the input speech signal. Then, the waveform correction module 112 interpolates a speech signal in the deleted n frame by using frames preceding and following the n frame, namely an n−1 frame and an n+1 frame. In this interpolation, a window function, such as a Hanning window, may be used. In this case, the waveform correction module 112 may add a signal which is obtained by multiplying a signal in the n−1 frame by a first window function, and a signal which is obtained by multiplying a signal in the n+1 frame by a second window function having a time direction reverse to the time direction of the first window function, and may use the added result in place of the speech signal in the deleted n frame.

As has been described above, in the present embodiment, since the tap sound signal, which is non-stationary noise, can automatically be eliminated from the input speech signal, other operations can be executed during the speech input, without causing degradation in precision of speech recognition.

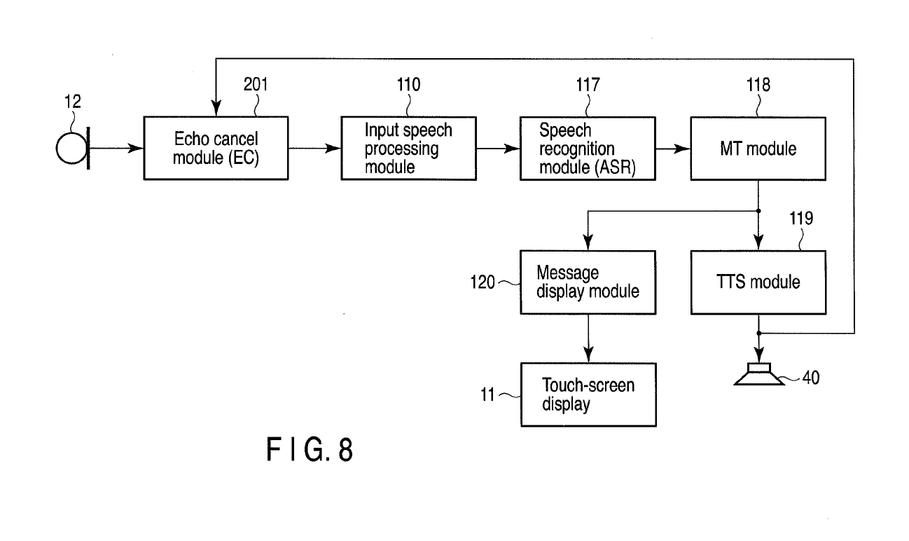

FIG. 8 illustrates another example of the system configuration of the portable electronic device. The system configuration of FIG. 8 includes an echo cancel module 201 in order to enable a speech input even while a sound corresponding to a speech signal obtained by the text-to-speech (TTS) module 119 is being produced. The echo cancel module 201 may be provided, for example, at a front stage of the input speech processing module 110. The echo cancel module 201 eliminates, from the input speech signal, that component of the speech signal output from the text-to-speech (TTS) module 119, which has entered the microphone. Thereby, the present output sound from the loudspeaker 40, which is included in the input speech signal, can be eliminated. Therefore, the shop assistant 31, for example, can utter a speech, without waiting for the completion of the output of the speech which is obtained by recognizing, translating and speech-synthesizing his/her own speech.

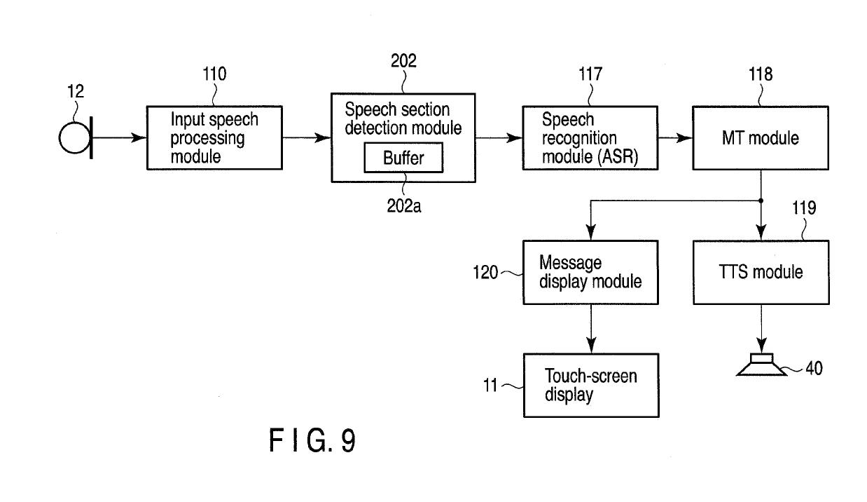

FIG. 9 illustrates still another example of the system configuration of the portable electronic device. The system configuration of FIG. 9 includes a speech section detection module 202 in order to make it possible to automatically start a speech input at an arbitrary timing. The speech section detection module 202 may be provided, for example, at a following stage of the input speech processing module 110.

The speech section detection module 202 includes a buffer (memory) 202a which stores an input speech signal which has been processed by the input speech processing module 110. The speech section detection module 202 detects a speech section in the input speech signal stored in the buffer 202a. The speech section is a period in which a speaker utters a speech. The speech section detection module 202 outputs a speech signal, which is included in the input speech signal stored in the buffer 202a and belongs to the detected speech section, to the speech recognition section (ASR) 117 as a speech signal which is a target of recognition. In this manner, by detecting the speech section by the speech section detection module 202, it is possible to start speech recognition and machine translation at a proper timing, without the need to press the speech start button 18.

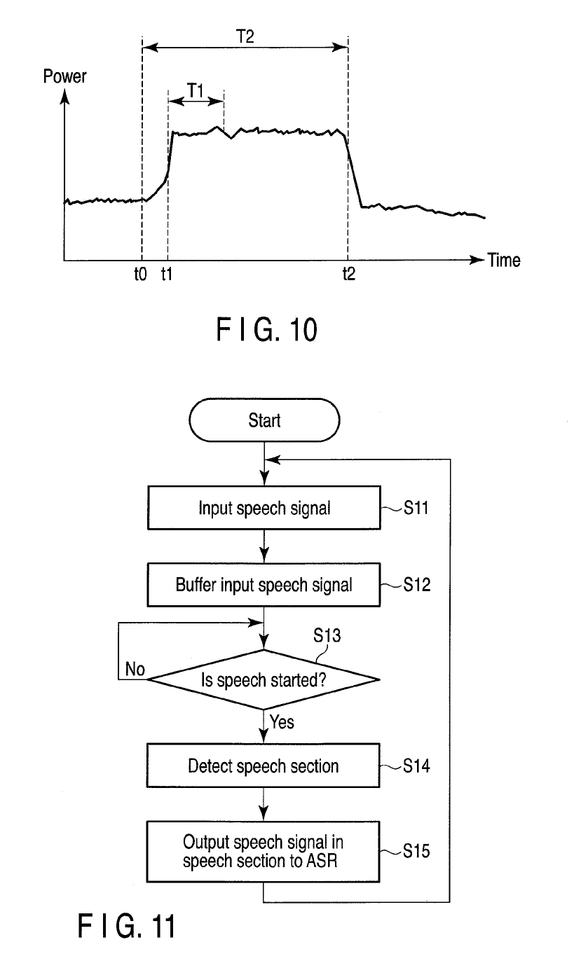

Next, referring to FIG. 10, an example of the operation of detecting a speech section is described. In FIG. 10, the lateral axis indicates time, and the vertical axis indicates a signal intensity level (power) of an input speech signal. The intensity level of the input speech signal exceeds a certain reference value, for example, at a timing t1. When the state in which the intensity level of the input speech signal exceeds the reference value continues for a certain period T1 from the timing t1, the speech section detection module 202 detects that a speech has been started. In this case, the speech section detection module 202 may recognize, for example, a period from a timing t0, which is shortly before the timing t1, to a timing t2 at which the intensity level of the input speech signal lowers below the reference level, that is, a period T2, as a speech section. The speech section detection module 202 reads a speech signal belonging to the speech section from the buffer 202a and outputs the read speech signal to the following stage.

A flow chart of FIG. 11 illustrates the procedure of the speech section detection process. A speech signal is input from the microphone 12 to the input speech processing module 110, and the input speech processing module 110 processes the input speech signal (step S11). The speech section detection module 202 buffers a speech signal, which is output from the input speech processing module 110, in the buffer 202a (step S12). The speech section detection module 202 determines whether a speech has been started or not, based on the intensity level of the buffered speech signal (step S13). If a speech has been started, the speech section detection module 202 detects a speech section (step S14), and outputs a speech signal belonging to the speech section to the speech recognition (ASR) module 117 (step S15).

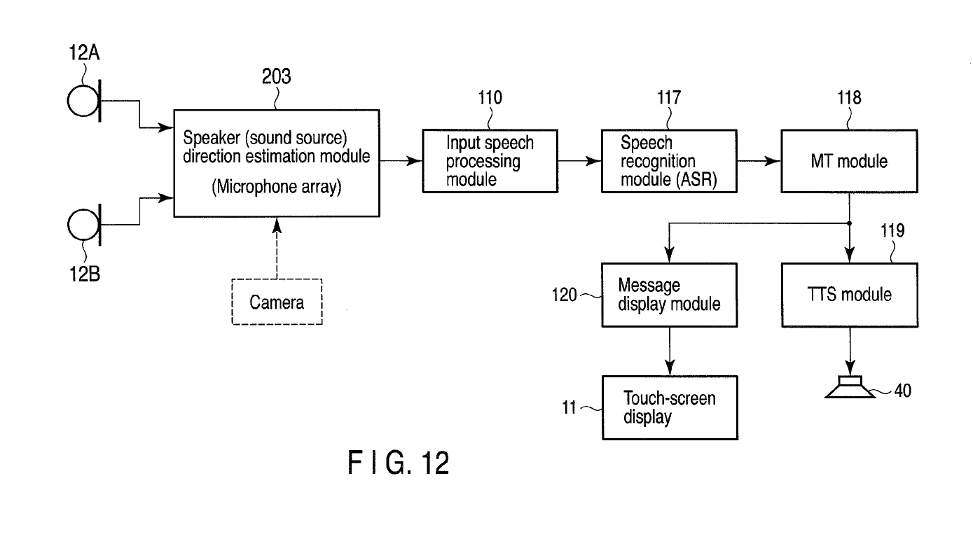

FIG. 12 illustrates still another example of the system configuration of the portable electronic device. The system configuration of FIG. 12 includes a plurality of microphones 12A and 12B and a speaker direction estimation module 203 in order to make it possible to input and recognize a speech of a specified person even when a plurality of persons are speaking at the same time. The speaker direction estimation module 203 may be provided at the front stage of the input speech processing module 110.

The speaker direction estimation module 203, in cooperation with the microphones 12A and 12B, functions as a microphone array which can extract a sound from a sound source (speaker) located in a specified direction. Using input speech signals from the microphones 12A and 12B, the speaker direction estimation module 203 estimates the direction (speaker direction) in which the sound source (speaker) corresponding to each of the input speech signals is located relative to the main body 10 of the portable electronic device. For example, a speech of a speaker, who is located at, e.g. an upper left direction of the main body 10 of the portable electronic device, reaches the microphone 12A at first and then reaches the microphone 12B with a delay. Based on the delay time and the distance between the microphone 12A and microphone 12B, the sound source direction (speaker direction) corresponding to the input speech signal can be estimated. Based on the estimation result of the speaker direction, the speaker direction estimation module 203 extracts (selects), from the input speech signals input by the microphones 12A and 12B, an input speech signal from the specified direction relative to the main body 10 of the portable electronic device. For example, when the speech of the shop assistant 31 is to be extracted, the speech signal, which is input from, e.g. the upper left of the main body 10 of the portable electronic device, may be extracted (selected). In addition, when the speech of the foreigner 32 is to be extracted, the speech signal, which is input from, e.g. the upper right of the main body 10 of the portable electronic device, may be extracted (selected). The input speech processing module 110 executes the above-described waveform correction process on the extracted input speech signal from the specified direction. In addition, processes of speech recognition, machine translation and speech synthesis are executed on the input speech signal from the specified direction, which has been subjected to the waveform correction process.

Thus, even when a plurality of persons are speaking at the same time, only the speech from a specified direction can be processed. Therefore, the speech of the specified person, for instance, the shop assistant 31 or foreigner 32, can correctly be input and recognized, without being affected by the speeches of speakers other than the shop assistant 31 or foreigner 32.

Alternatively, the face of each of persons around the main body 10 of the portable electronic device may be detected by using a camera, and the direction in which a face similar to the face of the shop assistant 31 is present may be estimated as the direction in which the shop assistant 31 is located relative to the main body 10 of the portable electronic device. Besides, a direction, which is opposite to the direction in which a face similar to the face of the shop assistant 31 is present, may be estimated as the direction in which the foreigner 32 is located relative to the main body 10 of the portable electronic device. Although speeches of speakers, other than the shop assistant 31 or foreigner 32, are non-stationary noise, only the speech of the shop assistant 31 or foreigner 32 can be extracted by the system configuration of FIG. 12, and therefore the influence due to the non-stationary noise can be reduced.

In addition, in the portable electronic device, the speech signal, which is input from a first direction (e.g. upper-left direction) of the main body 10, is subjected to a machine translation process for translation from a first language (Japanese in this example) into a second language (English in this example). The speech signal, which is input from a second direction (e.g. upper-right direction) of the main body 10, is subjected to a machine translation process for translation from the second language (English in this example) into the first language (Japanese in this example). A translation result, which is obtained by subjecting the speech signal input from the upper-left direction to the machine translation for translation from the first language into the second language, and a translation result, which is obtained by subjecting the speech signal input from the upper-right direction to the machine translation for translation from the second language into the first language, are output. In this manner, the content of the machine translation, which is applied to the speech signal, can be determined in accordance with the input direction of the speech signal (speaker direction). Therefore, the speech of the shop assistant 31 and the speech of the foreigner 32 can easily be translated into English and Japanese, respectively.

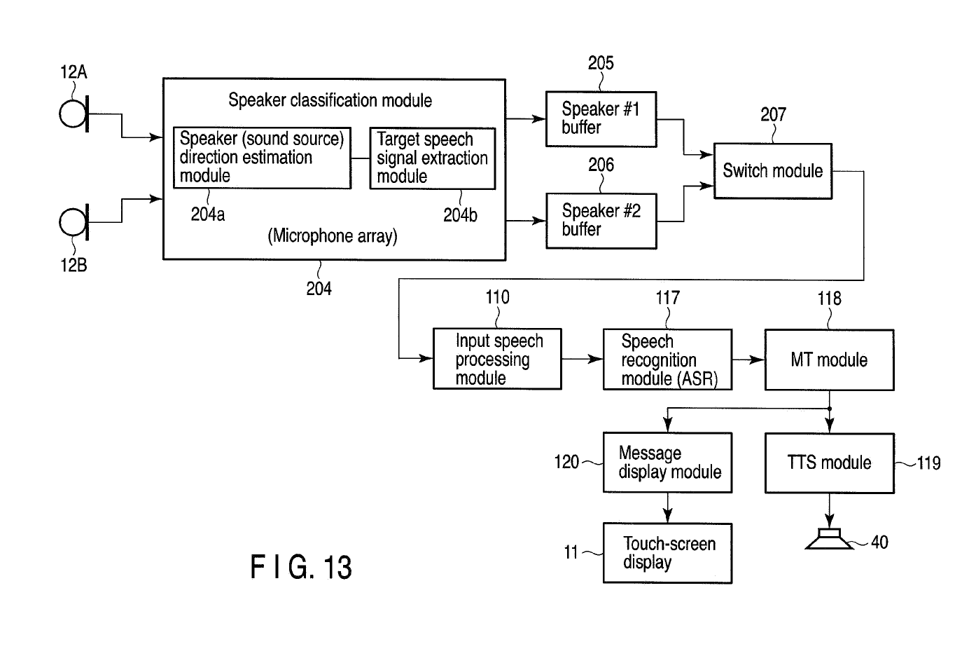

FIG. 13 illustrates still another example of the system configuration of the portable electronic device. The system configuration of FIG. 13 includes a plurality of microphones 12A and 12B and a speaker classification module 204 in order to make it possible to input and recognize a speech on a speaker-by-speaker basis when a plurality of persons are speaking at the same time. The speaker classification module 204 may be provided at the front stage of the input speech processing module 110.

The speaker classification module 204 also functions as a microphone array. The speaker classification module 204 comprises a speaker direction estimation module 204a and a target speech signal extraction module 204b. Using input speech signals from the microphones 12A and 12B, the speaker direction estimation module 204a estimates the direction in which the sound source (speaker) corresponding to each of the input speech signals is located relative to the main body 10 of the portable electronic device. Based on the estimation result of the direction of each of the speakers, the target speech signal extraction module 204b classifies the input speech signals from the microphones 12A and 12B on a speaker-by-speaker basis, that is, in association with the individual directions of the sound source. For example, a speech signal from, e.g. the upper left of the main body 10 of the portable electronic device is determined to be the speech of the shop assistant 31, and is stored in a speaker #1 buffer 205. A speech signal from, e.g. the upper right of the main body 10 of the portable electronic device is determined to be the speech of the foreigner 32, and is stored in a speaker #2 buffer 206.

A switch module 207 alternately selects the speaker #1 buffer 205 and speaker #2 buffer 206 in a time-division manner. Thereby, the input speech processing module 110 can alternately process the speech signal of the shop assistant 31 and the speech signal of the foreigner 32 in a time-division manner. Similarly, the speech recognition module 117, machine translation module 118, TTS module 119 and message display module 120 can alternately process the speech signal of the shop assistant 31 and the speech signal of the foreigner 32 in a time-division manner. The recognition result of the speech of the shop assistant 31 is subjected to the machine translation for translation from Japanese into English, and the translation result is output by audio or by text display. In addition, the recognition result of the speech of the foreigner 32 is subjected to the machine translation for translation from English into Japanese, and the translation result is output by audio or by text display.

In the meantime, a plurality of speech process blocks, each including the input speech processing module 110, machine translation module 118, TTS module 119 and message display module 120, may be provided, and speech signals of a plurality of speakers may be processed in parallel.

As has been described, according to the present embodiment, since the influence of non-stationary noise, such as a tap sound signal, can be reduced, other various operations using a tap operation can be executed while a speech is being input. Thus, for example, even while a shop assistant is having a conversion with a foreigner by using the portable electronic device of the embodiment, the shop assistant can perform such an operation as tapping the touch-panel display 11 of the portable electronic device and displaying an image, such as a guidance of a sales floor, on the touch-panel display 11.

In the meantime, use can be made of a configuration including some or all of the echo cancel module 201 of FIG. 8, the speech section detection module 202 of FIG. 9, the speaker direction estimation module 203 of FIG. 12 and the speaker classification module 204 of FIG. 13.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable electronic device comprising:
a main body;
a touch-screen display;
at least one microphone attached to the main body;
a speech processing module in the main body and configured to process an input speech signal from the at least one microphone; and
a translation result output module in the main body, the translation result output module configured to output a translation result associated with a target language, wherein the translation result of the target language is obtained by machine-translating the input speech signal,
wherein the speech processing module is configured to detect a tap sound signal in the input speech signal, the tap sound signal produced by tapping the touch-screen display, the speech processing module further configured to reduce an influence of the detected tap sound signal upon the input speech signal.

2. The portable electronic device of claim 1, wherein the speech processing module reduces an influence of the detected tap sound signal upon the input speech signal by correcting the input speech signal.

3. The portable electronic device of claim 1, wherein the translation result output module is further configured to convert text associated with the translation result of the target language to a speech signal, and to output a sound corresponding to the speech signal obtained by the conversion.

4. The portable electronic device of claim 1, wherein the translation result output module is configured to convert text associated with the translation result of the target language to a speech signal, to output a sound corresponding to the speech signal obtained by the conversion, and to display the text indicative of the translation result of the target language on the touch-screen display.

5. The portable electronic device of claim 1,
wherein the translation result output module is configured to convert text associated with the translation result of the target language to a speech signal, and to output a speech signal including a sound corresponding to the speech signal obtained by the conversion, and
wherein the portable electronic device further comprises an echo cancel module configured to reduce a speech signal component from the input speech signal, the speech signal component including the speech signal obtained by the conversion.

6. The portable electronic device of claim 5, wherein the echo cancel module is configured to reduce a speech signal component from the input speech signal in order to enable a speech input while the speech signal including the sound corresponding to the speech signal obtained by the conversion is being output.

7. The portable electronic device of claim 1, further comprising:
a buffer configured to store the input speech signal which is processed by the speech processing module; and
a speech detection module configured to detect a speech section in the input speech signal stored in the buffer, and to output a portion of the detected speech section as a target of recognition speech signal.

8. The portable electronic device of claim 7, wherein the portion of the detected speech section is included in the input speech signal stored in the buffer.

9. The portable electronic device of claim 1,
wherein a plurality of microphones are attached to the main body, and
wherein the portable electronic device further comprises a speaker direction estimation module configured to estimate a direction in which a speaker is located relative to the main body based on speech signals from the plurality of microphones, the speaker direction estimation module further configured to extract an input speech signal from the input speech signals in a direction relative to the main body based on a result of the estimation.

10. The portable electronic device of claim 1,
wherein a plurality of microphones are attached to the main body, and
wherein the portable electronic device further comprises a speaker classification module configured to estimate a direction in which a speaker is located relative to the main body based on the input speech signals from the plurality of microphones, the speaker classification module further configured to classify the input speech signals from the plurality of microphones on a speaker-by-speaker basis based on a result of the estimation.

11. A portable electronic device comprising:
a main body with a touch-screen display, the touch-screen display configured to display a guidance screen;
at least one microphone attached to the main body;
a speech processing module in the main body and configured to process input speech signals from a guide and the guided person with use of the at least one microphone; and
a translation result output module provided in the main body, the translation result output module configured to output a first translation result associated with a first language and to output a second translation result associated with a second language, the first and second translation results obtained by machine-translating an input speech signal of the guide which has been processed by the speech processing module,
wherein the speech processing module is configured to:
detect a tap sound signal produced by tapping the touch-screen display, the tap sound signal included in the input speech signal from each of the guide and the guided person; and
correct the input speech signal to eliminate the detected tap sound signal from the input speech signal.

12. The portable electronic device of claim 11, wherein the guidance screen is for guiding a person on the touch-screen display and to execute a function which is associated with a display object corresponding to a tap position on the touch-screen display.

13. The portable electronic device of claim 11, wherein the translation result output module is further configured to output a translation result of a first language used by the guide, the translation result obtained by recognizing and machine-translating an input speech signal of the guided person which has been processed by the speech processing module.

14. The portable electronic device of claim 11, wherein the translation result output module is further configured to convert text associated with the translation result of the second language to a first speech signal, to convert text associated with the translation result of the first language to a second speech signal, and to output a sound corresponding to the first speech signal and a sound corresponding to the second speech signal.
